(19) United States
(12) Patent Application Publication
(10) Pub. No.: US 2022/0161734 A1
(43) Pub. Date: May 26, 2022

(54) Hitch Hanger

(71) Applicant: Shawn Michael Duyette, Berkeley, CA (US)

(72) Inventor: Shawn Michael Duyette, Berkeley, CA (US)

(21) Appl. No.: 17/535,491

(22) Filed: Nov. 24, 2021

Related U.S. Application Data
(60) Provisional application No. 63/117,916, filed on Nov. 24, 2020.

(51) Int. Cl. B60R 9/06; A47G 25/40

(52) U.S. Cl. CPC B60R 9/06; A47G 25/40

(57) ABSTRACT

The present invention is a hitch clothes hanger device that installs along a vehicle hitch connector. The clothes hitch hanger device contains a hanger body and at least one hanging element. The hanger body contains a hitch connection end, a hanger end, and a plurality of adjustment elements. The hitch connection end and the hanger end are terminally positioned opposite to each other along the hanger body. The plurality of adjustment elements is distributed about the hanger body, opposite to the hitch connection end. Each of the at least one hanging element is selectively engaged with each of the plurality of adjustment elements, where each of the at least one hanging element is angularly adjustable along the hanger body.

### FIELD OF THE INVENTION

The present invention generally relates to hangers. More specifically, the present invention relates to a clothesline device for use in conjunction with a vehicle.

### BACKGROUND OF THE INVENTION

A portable device for conveniently hanging clothing is in demand. People need to hang their clothing to dry after washing it during traveling, or when clothing becomes wet as a result of rain or for some other reason.

People who are on vacation, camping, or engaging in other activities when using a vehicle such as a trailer may need to dry their clothing after swimming or doing laundry by hand, but most such vehicles and trailers are not equipped with a machine dryer. Sometimes people drape their clothes over a chair or a portion of their vehicle to dry, but such approaches do not allow for efficient drying and can dirty the wet clothing by bringing it into contact with surface dust or may damage the surface used for hanging.

Sometimes a chair or other surface is simply unavailable for hanging clothes. Manufacturers have introduced various clothes hangers that can be adapted for use in vehicles. Some are collapsible and designed to attach to the back of a vehicle by a mount. Other devices are designed to attach to a trailer via separate mounting plates. However, these devices are heavy and bulky, making them difficult to use during travel.

They are not easily foldable or mountable to a vehicle and do not incorporate the convenience and portability of a clothesline. Thus, there is a need to develop a device that solves these problems.

The present invention is intended to address problems associated with and/or otherwise improve on conventional devices through an innovative hanger device that is designed to be convenient to carry and install on a vehicle while incorporating other problem-solving features.

### SUMMARY OF THE INVENTION

The present invention is a hitch clothes hanger device that installs along a vehicle hitch connector. The clothes hitch hanger device comprises a hanger body and at least one hanging element. The hanger body comprises a hitch connection end, a hanger end, and a plurality of adjustment elements. The hitch connection end and the hanger end are terminally positioned opposite to each other along the hanger body. The plurality of adjustment elements is distributed about the hanger body, opposite to the hitch connection end. Each of the at least one hanging element is selectively engaged with each of the plurality of adjustment elements, where each of the at least one hanging element is angularly adjustable along the hanger body.

### BRIEF DESCRIPTION OF THE DRAWINGS

FIG. 1 is a perspective view of the present invention installed along a vehicle hitch connector.

FIG. 2 is a perspective view of the present invention that shows a deployed configuration.

FIG. 3 is a detailed view taken along circle A in FIG. 2.

FIG. 4 is a perspective view of the present invention that shows a transition from the deployed configuration to a retracted configuration.

FIG. 5 is a detailed view taken along circle D in FIG. 4.

FIG. 6 is a top perspective view of the present invention that shows the retracted configuration.

FIG. 7 is a detailed view taken along circle B in FIG. 6.

FIG. 8 is a detailed view taken along circle C in FIG. 6.

FIG. 9 is a perspective view of the present invention, in accordance with another embodiment.

FIG. 10 is a perspective view of the present invention, in accordance with another embodiment that shows a transition from the retracted configuration to the deployed configuration.

FIG. 11 is a perspective view of the present invention, in accordance with another embodiment installed along a vehicle hitch connector.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

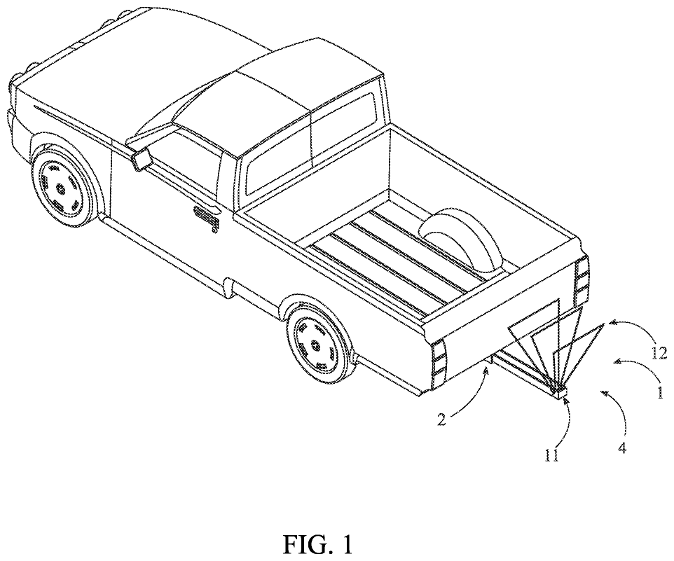

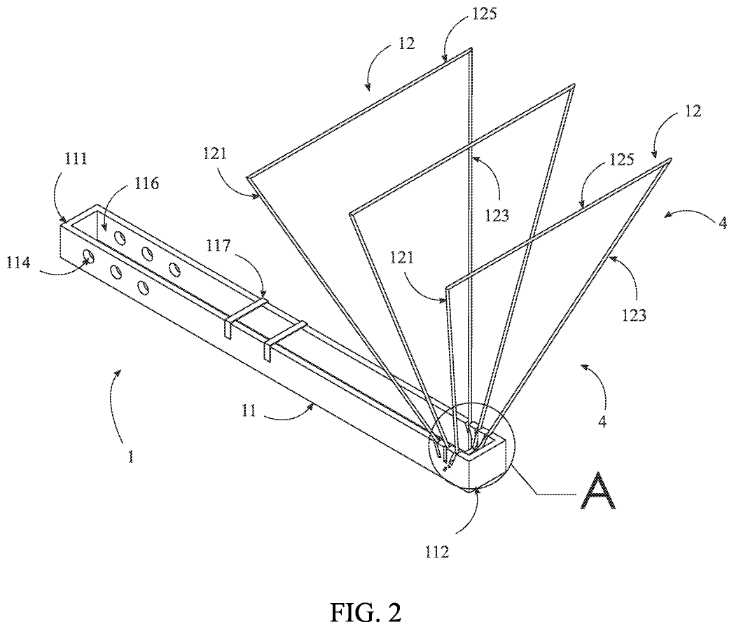

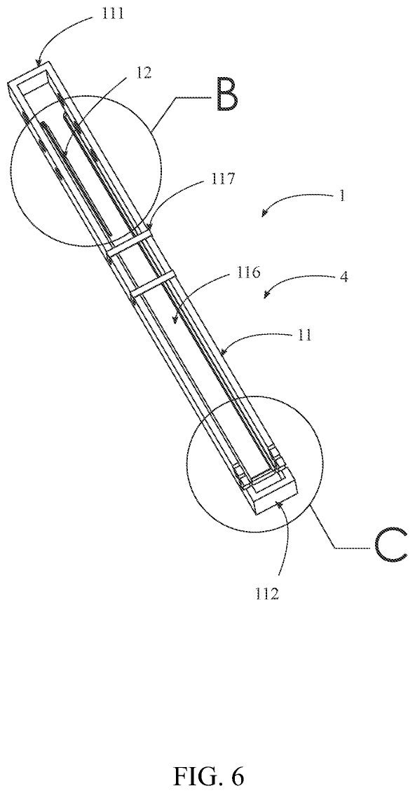

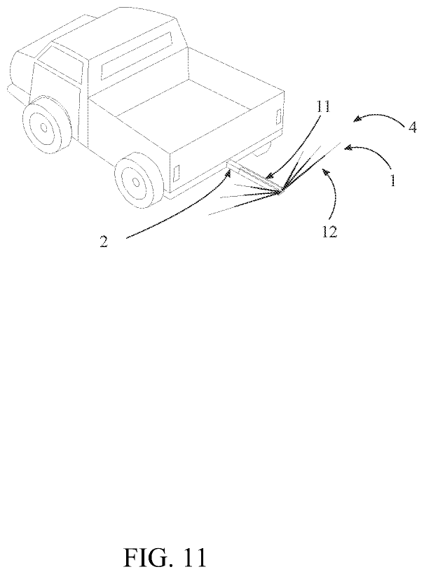

In reference to FIGS. 1-2, 4, 6, and 9-11, the present invention is a hitch hanger device 1. The hitch hanger device 1 comprises a hanger body 11 and at least one hanging element 12. In reference to FIGS. 2-4, the hanger body 11 comprises a hitch connection end 111, a hanger end 112, and a plurality of adjustment elements 113. The hitch connection end 111 and the hanger end 112 are terminally positioned opposite to each other along the hanger body 11. The plurality of adjustment elements 113 is distributed about the hanger body 11, opposite to the hitch connection end 111. Each of the at least one hanging element 12 is selectively engaged with each of the plurality of adjustment elements 113, where each of the at least one hanging element 12 is angularly adjustable along the hanger body 11 through the plurality of adjustment elements. The hitch hanger device 1 installs along an existing vehicle hitch such that the hitch hanger device 1 provides a means of hanging and drying clothes articles along the hitch hanger device 1. The hitch hanger device 1 is suitable for situations where a dryer is not available. The hanger body 11 serves as the main chassis of the hitch hanger device 1 that holds the associative components that constitutes the hitch hanger device 1. In the preferred embodiment, the hanger body 11 is made out of any suitable material that is durable, cost effective, lightweight, or non-corrosive. Such materials may include but are not limited to steel, aluminum, fiberglass, nylon polymer, carbon fiber, or any other suitable material. In the preferred embodiment, the hanger body 11 is scaled and shaped to slip into a vehicle hitch connector 2. In one embodiment, the hanger body 11 is rectangular in shape and scaled to the inner profile of the vehicle hitch connector 2 aperture in order to install along a rectangular hitch connector but may take the form of any other suitable shape or scale to adapt to various vehicle hitch connectors 2. In the preferred embodiment, the at least one hanging element 12 serves as the hanging agent of the hitch hanger device 1. The at least one hanging element 12 is configured into a retracted configuration 4, shown in FIG. 6, allowing the user to easily store and handle the hitch hanger device 1, and is configured to a deployed configuration 3 when in use, as shown in FIGS. 1-2 and 11. In the preferred embodiment, the at least one hanging element 12 is made out of any suitable material such as, but not limited to aluminum, steel, nylon, fiberglass, carbon fiber, or any other suitable material. The hitch connection end 111 of the hanger body 11 facilitates the installation of the hanger body 11 along the vehicle hitch connector 2. The hanger end 112 mounts and secures the at least one hanging element 12 along the hanger body 11, such that the at least one hanging element 12 is projected distal from the vehicle hitch connector 2. The plurality of adjustment elements 113 selectively engages the at least one hanging element 12 such that the at least one hanging element 12 is adjusted, erected, and set to desired angles along the hanger body 11. In the preferred embodiment, the plurality of adjustment elements 113 is a plurality of notches oriented at different angles, selectably receiving and positioning the at least one hanging element into at least one of the plurality of notches and thereby determining the orientation of the at least one hanging element.

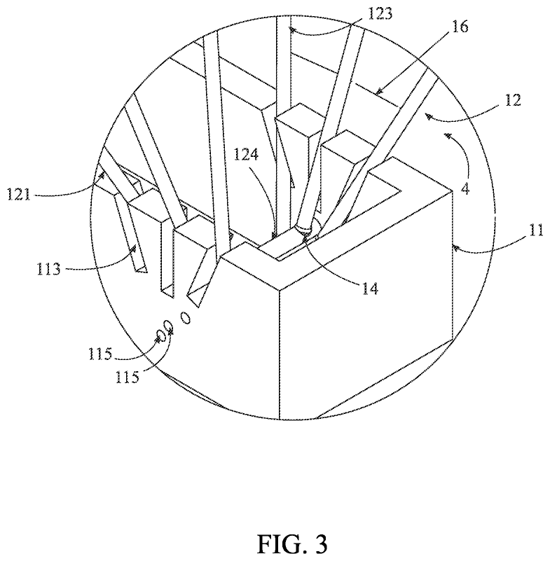

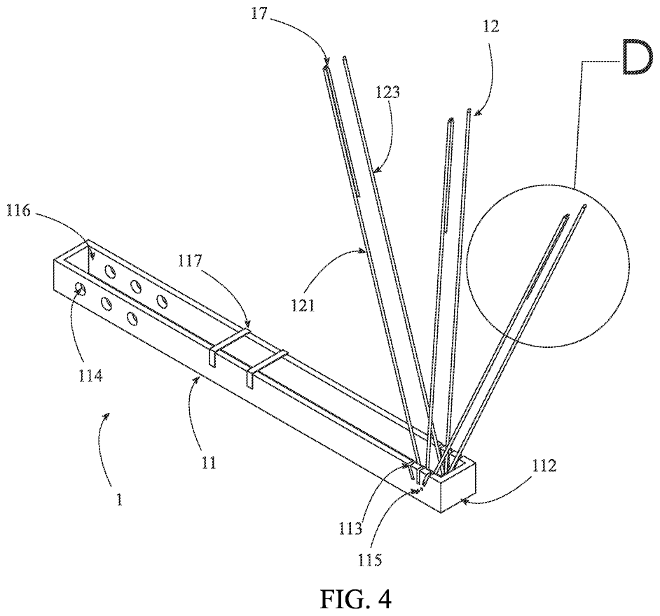

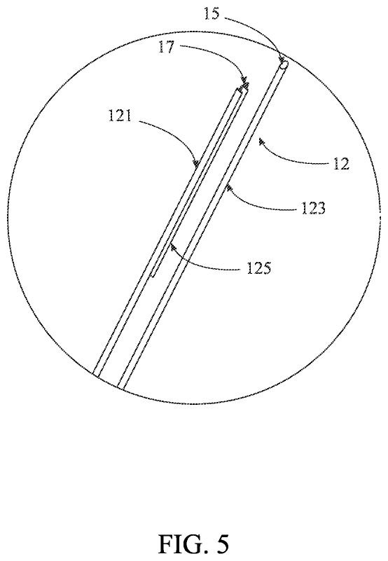

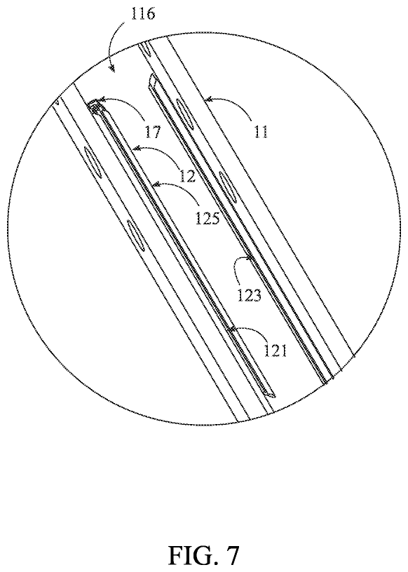

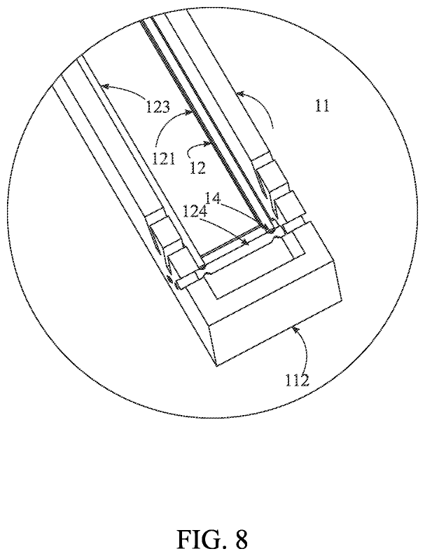

In reference to FIGS. 2 and 4, the hanger body 11 further comprises a plurality of hitch apertures 114. The plurality of hitch apertures 114 is distributed about the hanger body 11, opposite to the hanger end 112. The plurality of hitch apertures 114 serves as connection points, co-aligning with a pin hole of the vehicle hitch connector such that a pin of the vehicle hitch connector installs and connects along one of the plurality of hitch apertures 114 to the vehicle hitch connector pin hole. In the preferred embodiment, the hanger body 11 further comprises a plurality of hanger apertures 115, as shown in FIG. 3. The plurality of hanger apertures 115 is distributed about the hanger body 11, opposite to the hitch connection end 111. In reference to FIGS. 2-8, each of the at least one hanging element 12 comprises a first pole 121, a second pole 123, an axle 124, and a support beam 125. The axle 124 of each of the at least one hanging element 12 is rotatably positioned within one of the plurality of hanger apertures 115. The first pole 121 and the second pole 123 are each pivotally connected to the axle 124 through a pivot connector 14 and positioned opposite to each other along the axle 12. The support beam 125 is connected between the first pole 121 and the second pole 123, opposite to the axle 124, through a connection element 15. The first pole 121 and the second pole 123 are each selectively engaged with one of the plurality of adjustment elements 113. In the preferred embodiment, the plurality of hanger apertures 115 serves as mounting holes that installs the axle 124 of each of the at least one hanging element 12 to the hanger body 11. The first pole 121 and the second pole 123 serve as upright pole members that project and mount the support beam 125. The support beam 125 serves as a lateral pole member that serves as the primary clothes hanging pole of the at least one hanging element 12 where the user can hang clothes along the support beam 125. In the preferred embodiment, the plurality of hanger apertures 115 is distributed in a specified pattern 16 about the hanger body 11, where the plurality of hanger apertures 115 is configured to nest the at least one hanging element 12 on top of each other in the retracted configuration 4, as shown in FIG. 6. This compacts the at least one hanging element 12 into a storable form.

The hanger body 11 further comprises a hanger channel 116, as shown in FIGS. 2, 4, and 6. The hanger channel 116 traverses from the hitch connection end 111 to the hanger end 112. Each of the at least one hanging element 12 is positioned within the hanger channel 116, where each of the at least one hanging element 12 is configured to store along the hanger channel 116 in the retracted configuration 4. The support beam 125 is connected adjacent to the first pole 121 through a connection cord 17. The first pole 121, the second pole 123, and the support beam 125 are positioned within the hanger channel 116, where the first pole 121, the second pole 123, and the support beam 125 are configured to be stored along the hanger channel 116 in the retracted configuration 4. In the preferred embodiment, the connection cord 17 may take the form of a bungee cord that links the first pole 121 to the second pole 123.

In the preferred embodiment, the support beam 125 is connected adjacent to the second pole 123, opposite to the first pole 121, through a connection element 15. The first pole 121 and the second pole 123 are selectively engaged with the plurality of adjustment elements 113, where each of the at least one hanging element 12 is angularly connected along the hanger body 11 in a specified pattern 16 in the deployed configuration 3, as shown in FIG. 3. In the preferred embodiment, the connection element 15 removably attaches the second pole 123 to the support beam 125 such that the user can quickly and easily disassemble or assemble the at least one hanger element. The connection element 15 may take the form of any suitable connector such as but not limited to quick detach connections, slip on couplers, threaded connectors, magnetic clasps, or any other suitable connector implement. In the preferred embodiment, the specified pattern 16 may take the form of any suitable pre-set pattern optimal in positioning the at least one hanger element along the hanger body 11. In one embodiment, the specified pattern 16 may take the form of 20-degree angular offsets but may take the form of any suitable pattern.

In the preferred embodiment, the hitch hanger device 1 further comprises a handle element 117, as shown in FIGS. 2, 4, and 6. The handle element 117 is connected adjacent to the hanger body 11, where the handle element 117 is configured to secure the at least one hanging element 12 within the hanger channel 116 in the retracted configuration 4. The hitch hanger may take the form of strap webbings that wrap across the hanger body 11 such that the handle element 117 prevents the at least one hanger element from unintentionally deploying out of the hanger channel 116. Furthermore, the handle element 117 serves as a grasping implement, allowing the user to grab along the handle element 117 to easily handle and transport the hitch hanger device 1 by hand.

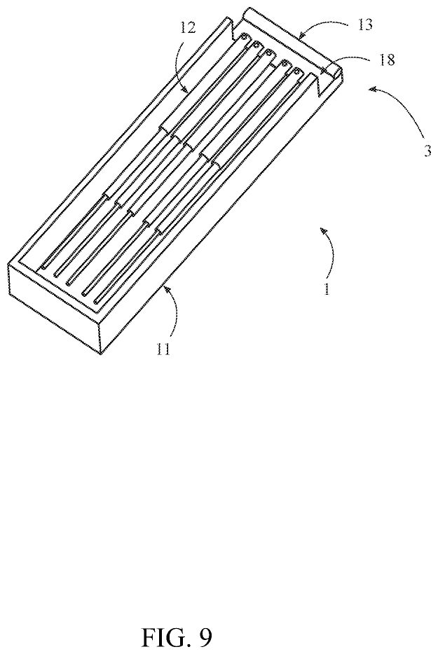

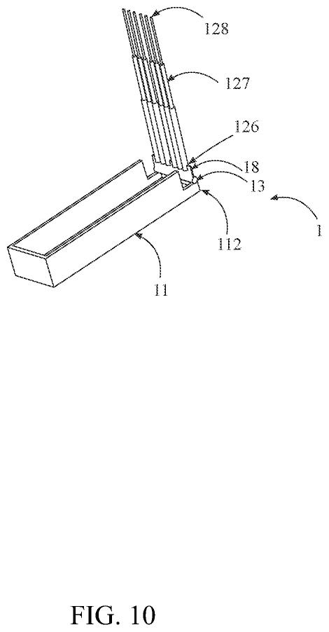

In another embodiment, the hitch hanger device 1 further comprises a base connector 18, as shown in FIGS. 9-10. In reference to FIGS. 9-11, each of the at least one hanging element 12 further comprises a base end 126, a plurality of telescopic rods 127, and a mounting end 128. The base connector 18 is hingedly connected adjacent to the hanger end 112 through a hinge connector 13, as shown in FIGS. 9-10. The base end 126 of each of the at least one hanging element 12 is pivotally connected and distributed about the base connector 18. The plurality of telescopic rods 127 is connected adjacent to the base end 126, opposite to the base connector 18, where the plurality of telescopic rods 127 is configured to adjust the at least one hanging element 12 in length. The mounting end 128 is connected adjacent to the plurality of telescoping rods, opposite to the base end 126. In this embodiment, the hinge connector 13 is a friction hinge.

Although the invention has been explained in relation to its preferred embodiment, it is to be understood that many other possible modifications and variations can be made without departing from the spirit and scope of the invention as hereinafter claimed.

What is claimed is:

1. A hitch hanger device comprising:
a hanger body;
at least one hanging element;
the hanger body comprising a hitch connection end, a hanger end, and a plurality of adjustment elements;
the hitch connection end and the hanger end being terminally positioned opposite to each other along the hanger body;
the plurality of adjustment elements being distributed about the hanger body, opposite to the hitch connection end; and
each of the at least one hanging element being selectively engaged with each of the plurality of adjustment elements, wherein each of the at least one hanging element is angularly adjustable along the hanger body through the plurality of adjustment elements.

2. The hitch hanger device as claimed in claim 1 comprising:
the hanger body further comprises a plurality of hitch apertures; and
the plurality of hitch apertures being distributed about the hanger body, opposite to the hanger end.

3. The hitch hanger device as claimed in claim 1 comprising:
the hanger body further comprises a plurality of hanger apertures; and
the plurality of hanger apertures being distributed about the hanger body, opposite to the hitch connection end.

4. The hitch hanger device as claimed in claim 3 comprising:
each of the at least one hanging element comprising a first pole, a second pole, an axle, and a support beam;
the axle of each of the at least one hanging element being rotatably positioned within one of the plurality of hanger apertures;
the first pole and the second pole each being pivotally connected to the axle through a pivot connector and positioned opposite to each other along the axle;
the support beam being connected between the first pole and the second pole, opposite to the axle, through a connection element; and
the first pole and the second pole each being selectively engaged with one of the plurality of adjustment elements.

5. The hitch hanger device as claimed in claim 4 comprising:
the plurality of hanger apertures being distributed in a specified pattern about the hanger body, wherein the plurality of hanger apertures is configured to nest the at least one hanging element on top of each other in a retracted configuration.

6. The hitch hanger device as claimed in claim 1 comprising:
the hanger body further comprises a hanger channel; and
the hanger channel traversing from the hitch connection end to the hanger end;

7. The hitch hanger device as claimed in claim 6 comprising:
each of the at least one hanging element being positioned within the hanger channel, wherein each of the at least one hanging element is configured to store along the hanger channel in a retracted configuration.

8. The hitch hanger device as claimed in claim 6 comprising:
each of the at least one hanging element comprising a first pole, a second pole, an axle, and a support beam;
the axle of each of the at least one hanging element being rotatably positioned within one of the plurality of hanger apertures;
the first pole and the second pole each being pivotally connected to the axle through a pivot connector and positioned opposite to each other along the axle;
the support beam being connected adjacent to the first pole through a connection cord; and
the first pole, the second pole, and the support beam being positioned within the hanger channel, wherein the first pole, the second pole, and the support beam is configured to store along the hanger channel in a retracted configuration.

9. The hitch hanger device as claimed in claim 1 comprising:
each of the at least one hanging element comprising a first pole, a second pole, an axle, and a support beam;
the axle of each of the at least one hanging element being rotatably positioned within one of the plurality of hanger apertures;
the first pole and the second pole each being pivotally connected to the axle through a pivot connector and positioned opposite to each other along the axle;
the support beam being connected adjacent to the first pole through a connection cord;
the support beam being connected adjacent to the second pole, opposite to the first pole, through a connection element; and
the first pole and the second pole each being selectively engaged with one of the plurality of adjustment elements, wherein each of the at least one hanging element is angularly connected along the hanger body in a specified pattern in a deployed configuration.

10. The hitch hanger device as claimed in claim 1 comprising:
a handle element; and
the handle element being connected adjacent to the hanger body, wherein the handle element is configured to secure the at least one hanging element within the hanger channel in a retracted configuration.

11. The hitch hanger device as claimed in claim 1 comprising:
a hanger channel;
the hanger channel traversing from the hitch connection end to the hanger end; and
each of the at least one hanging element being positioned within the hanger channel, wherein each of the at least one hanging element is configured to store along the hanger channel at least one hanging element in a retracted configuration.

12. The hitch hanger device as claimed in claim 1 comprising:
a hanger channel;
the hanger channel traversing from the hitch connection end to the hanger end;
each of the at least one hanging element comprising a first pole, a second pole, an axle, and a support beam;
the axle of each of the at least one hanging element being rotatably positioned within one of the plurality of hanger apertures;
the first pole and the second pole each being pivotally connected to the axle through a pivot connector and positioned opposite to each other along the axle; and
the support beam being connected adjacent to the first pole through a connection cord;
the first pole, the second pole, and the support beam being positioned within the hanger channel, wherein the first pole, the second pole, and the support beam is configured to store along the hanger channel in a retracted configuration.

13. The hitch hanger device as claimed in claim 1 comprising:
a hanger channel;
the hanger channel traversing from the hitch connection end to the hanger end;
each of the at least one hanging element being positioned within the hanger channel, wherein each of the at least one hanging element is configured to store along the hanger channel at least one hanging element in a retracted configuration.
each of the at least one hanging element comprising a first pole, a second pole, an axle, and a support beam;
the axle of each of the at least one hanging element being rotatably positioned within one of the plurality of hanger apertures;
the first pole and the second pole each being pivotally connected to the axle through a pivot connector and positioned opposite to each other along the axle;
the support beam being connected adjacent to the first pole through a connection cord; and
the first pole, the second pole, and the support beam being positioned within the hanger channel, wherein the first pole, the second pole, and the support beam is configured to store along the hanger channel in a retracted configuration.

14. The hitch hanger device as claimed in claim 1, wherein the plurality of adjustment elements is a plurality of adjustment notches.

15. The hitch hanger device as claimed in claim 1 comprising:
a base connector each of the at least one hanging element further comprising a base end, a plurality of telescopic rods, and a mounting end;
the base connector being hingedly connected adjacent to the hanger end through a hinge connector;
the base end of each of the at least one hanging element being pivotally connected and distributed about the base connector;
the plurality of telescopic rods being connected adjacent to the base end, opposite to the base connector, wherein the plurality of telescopic rods is configured to adjust the at least one hanging element in length; and
the mounting end being connected adjacent to the plurality of telescoping rods, opposite to the base end.

16. The hitch hanger device as claimed in claim 1, wherein the hinge connector is a friction hinge.

17. A hitch hanger device comprising:
a hanger body;
at least one hanging element;
the hanger body comprising a hitch connection end, a hanger end, a plurality of hitch apertures, a plurality of hanger apertures, a hanger channel, and a plurality of adjustment elements;
the hitch connection end and the hanger end being terminally positioned opposite to each other along the hanger body;
the hanger channel traversing from the hitch connection end to the hanger end;
the plurality of hitch apertures being distributed about the hanger body, opposite to the hanger end;
the plurality of hanger apertures being distributed about the hanger body, opposite to the hitch connection end;
the plurality of adjustment elements being distributed about the hanger body, opposite to the hitch connection end;
each of the at least one hanging element being selectively engaged with each of the plurality of adjustment elements, wherein each of the at least one hanging element is angularly adjustable along the hanger body.

18. A hitch hanger device comprising:
a hanger body;
at least one hanging element;
the hanger body comprising a hitch connection end, a hanger end, a plurality of hitch apertures, a plurality of hanger apertures, a hanger channel, and a plurality of adjustment elements;
each of the at least one hanging element comprising a first pole, a second pole, an axle, and a support beam;
the hitch connection end and the hanger end being terminally positioned opposite to each other along the hanger body;
the hanger channel traversing from the hitch connection end to the hanger end;
the plurality of hitch apertures being distributed about the hanger body, opposite to the hanger end;
the plurality of hanger apertures being distributed about the hanger body, opposite to the hitch connection end;
the plurality of adjustment elements being distributed about the hanger body, opposite to the hitch connection end;
the axle of each of the at least one hanging element being rotatably positioned within one of the plurality of hanger apertures;
the first pole and the second pole each being pivotally connected to the axle through a pivot connector and positioned opposite to each other along the axle;
the support beam being connected between the first pole and the second pole, opposite to the axle, through a connection element; and
each of the at least one hanging element being selectively engaged with each of the plurality of adjustment elements, wherein each of the at least one hanging element is angularly adjustable along the hanger body.
